(19) United States
(12) Patent Application Publication
(10) Pub. No.: US 2020/0333525 A1
(43) Pub. Date: Oct. 22, 2020

(54) Light Source Assembly, Backlight Module and Display Device

(71) Applicants: BEIJING BOE SPECIAL DISPLAY TECHNOLOGY CO., LTD., Beijing (CN); BOE TECHNOLOGY GROUP CO., LTD., Beijing (CN)

(72) Inventor: Ziyang Cheng, Beijing (CN)

(21) Appl. No.: 16/755,912

(22) PCT Filed: Jan. 14, 2019
(86) PCT No.: PCT/CN2019/071595

§ 371 Date: Apr. 14, 2020

(30) Foreign Application Priority Data
May 2, 2018 (CN) 201820641993.4

(51) Int. Cl. F21V 8/00

(52) U.S. Cl. CPC G02B 6/0031; G02B 6/0073

(57) ABSTRACT

The present disclosure relates to a light source assembly, a backlight module, and a display device. The light source assembly includes: a substrate; at least one light source on the substrate; and at least one buffer member located on the substrate and located on the same side of the substrate as the at least one light source, wherein, along an outward normal direction of a surface of the substrate, a maximum height of the at least one buffer member is greater than a maximum height of the at least one light source.

### CROSS-REFERENCE TO RELATED APPLICATIONS

This application is the United States national phase of International Application No. PCT/CN2019/071595 filed Jan. 14, 2019, and claims priority to China Patent Application No. 201820641993.4 filed on May 2, 2018, the disclosures of which are hereby incorporated by reference in their entirety.

### TECHNICAL FIELD

The present disclosure relates to a light source assembly, a backlight module, and a display device.

### BACKGROUND

In a liquid crystal display (LCD) device, the backlight module can provide a backlight to a liquid crystal panel, so that the liquid crystal panel displays a visual image viewable to a user.

Common backlight modules consist in such two forms as edge-type and direct-type. The edge-type backlight module contains a light guide plate, and the light emitted by the light source enters the light guide plate from a side of the light guide plate and outputs towards a top surface of the light guide plate under a reflection effect of the light guide plate. With gradual progress of the technology of the light emitting diode (LED), in the related art of an edge-type backlight module, a LED light bar is used as a main form of light source in the backlight module.

During installation of the LED light bar in the edge-type backlight module, the LED light is generally encapsulated on an aluminum substrate and then directly fixed on a backplane by a double-sided tape. The light emitted by the light bar can convert a multi-point light source on a side surface of the light guide plate into a surface light source on a top surface of the light guide plate through the light guide plate. In order to reduce the light loss, a small spacing is provided between the LED light bar and the light guide plate.

### SUMMARY

According to one aspect of the present disclosure, a light source is provided. The light source assembly includes: a substrate; at least one light source located on the substrate; and at least one buffer member located on the substrate and located on the same side of the substrate as the at least one light source, wherein a maximum height of the at least one buffer member is greater than a maximum height of the at least one light source.

In some embodiments, the light source assembly further includes: a reflector sheet located on one side of the at least one buffer member away from the substrate.

In some embodiments, a groove structure penetrating along an outward normal direction of a surface of the substrate is provided in the at least one buffer member, and the at least one light source is embedded within the groove structure.

In some embodiments, the light source assembly further includes a reflector sheet, wherein the reflector sheet is located on one side of the at least one buffer member away from the substrate and on an inner wall surface of the groove structure.

In some embodiments, the groove structure has a flared end along the outward normal direction of the surface of the substrate.

In some embodiments, the flared end has a flared angle of 40°˜60° along a thickness direction of a light guide plate.

In some embodiments, the flared end has a flared angle of 90°˜150° along a length direction of the substrate.

In another aspect of the present disclosure, a backlight module is provided. The backlight module includes: a light guide plate; and the light source assembly described above; wherein the light guide plate is located on one side of the at least one buffer member away from the substrate.

In some embodiments, a surface of the at least one buffer member is provided with a groove structure having a flared end along an outward normal direction of a surface of the substrate, and a flared size of the flared end along a thickness direction of the light guide plate is no greater than a thickness of the light guide plate.

According to another aspect of the present disclosure, a backlight module is provided. The backlight module includes: a light guide; and the light source assembly described above; wherein the light guide plate is located on one side of the at least one buffer member away from the substrate.

In some embodiments, a flared size of the flared end along a thickness direction of the light guide plate is no greater than a thickness of the light guide plate.

According to a further aspect of the present disclosure, a display device is provided. The display device includes the backlight module described above.

### BRIEF DESCRIPTION OF THE DRAWINGS

The accompanying drawings, which constitute part of this specification, illustrate exemplary embodiments of the present disclosure, and together with this specification, serve to explain the principles of the present disclosure.

The present disclosure can be more clearly understood from the following detailed description with reference to the accompanying drawings, in which:

FIG. 1 is a schematic cross-sectional view of a light source assembly according to an embodiment of the present disclosure;

FIG. 2 is a schematic structural view of a buffer member in an embodiment of a light source assembly according to the present disclosure;

FIG. 3 is a schematic structural view of a light source assembly according to an embodiment of the present disclosure;

FIG. 4 is an enlarged schematic view of a circle A in FIG. 3;

FIG. 5 is a schematic structural view of a backlight module according to an embodiment of the present disclosure.

It should be understood that the dimensions of the various parts shown in the accompanying drawings are not drawn according to the actual scale. In addition, the same or similar reference signs are used to denote the same or similar components.

### DETAILED DESCRIPTION

Various exemplary embodiments of the present disclosure will now be described in detail with reference to the accompanying drawings. The description of the exemplary embodiments is merely illustrative and is in no way intended as a limitation to the present disclosure, its application or use. The present disclosure can be implemented in many different forms, which are not limited to the embodiments described herein. These embodiments are provided to make the present disclosure thorough and complete, and fully convey the scope of the present disclosure to those skilled in the art. It should be noticed that: relative arrangement of components, numerical expressions, and numerical values set forth in these embodiments, unless specifically stated otherwise, should be explained as merely illustrative, and not as a limitation.

The words “first”, “second”, and similar words used in the present disclosure do not denote any order, quantity or importance, but merely serve to distinguish different parts. Such similar words as “comprising/including” or “containing” mean that the element preceding the word encompasses the elements enumerated after the word, and does not exclude the possibility of encompassing other elements as well. The terms “up”, “down”, “left”, “right”, or the like are used only to represent a relative positional relationship, and the relative positional relationship can be changed correspondingly if the absolute position of the described object changes.

In the present disclosure, when it is described that a particular device is located between the first device and the second device, there can be an intermediate device between the particular device and the first device or the second device, and alternatively, there can be no intermediate device. When it is described that a particular device is connected to other devices, the particular device can be directly connected to said other devices without an intermediate device, and alternatively, cannot be directly connected to said other devices but with an intermediate device.

All the terms (including technical and scientific terms) used in the present disclosure have the same meanings as understood by those skilled in the art of the present disclosure unless otherwise defined. It should also be understood that terms as defined in general dictionaries, unless explicitly defined herein, should be interpreted as having meanings that are consistent with their meanings in the context of the relevant art, and not to be interpreted in an idealized or extremely formalized sense.

Techniques, methods, and apparatus known to those of ordinary skill in the relevant art may not be discussed in detail, but where appropriate, these techniques, methods, and apparatuses should be considered as part of this specification.

After research, the inventor has found that, in some related arts of the edge-type backlight module, vibration can occur in some application scenarios (e.g., used in a vehicle or the like). Generally, in order to ensure the light guiding effect, there is a small spacing between the light source assembly (e.g., a LED light bar) and the light guiding plate. Moreover, when the edge-type backlight module vibrates, collision easily occurs between the light guide plate and the light source assembly, thereby further causing damage to the light source assembly.

In view of this, the embodiments of the present disclosure provide a light source assembly, a backlight module, and a display device, which can reduce the risk of damage to the light source assembly.

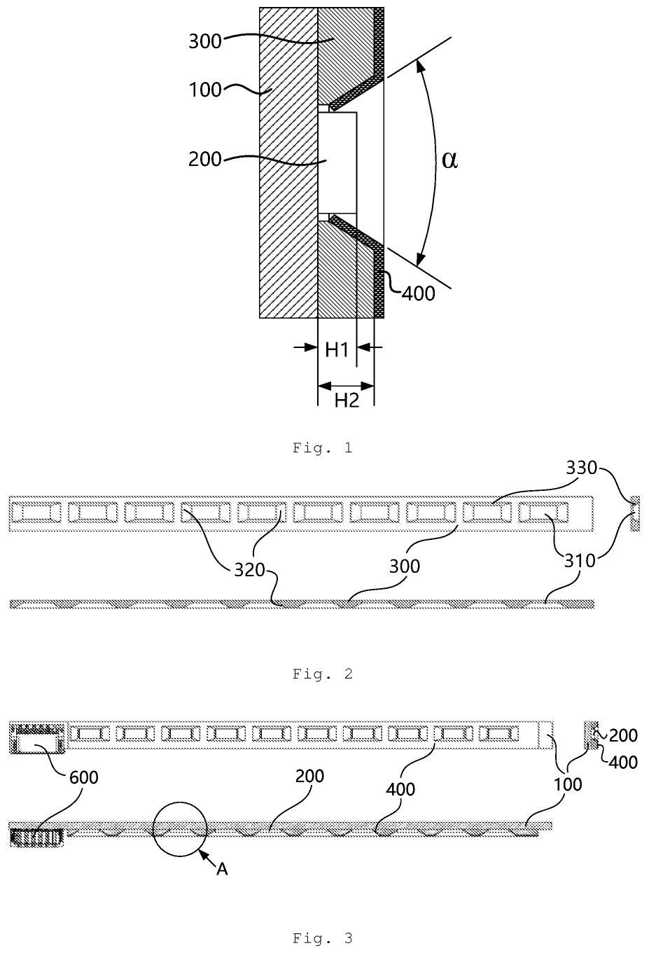

FIG. 1 is a schematic cross-sectional view of a light source assembly according to an embodiment of the present disclosure.

Referring to FIG. 1, in some embodiments, the light source assembly includes: a substrate 100, at least one light source 200, and at least one buffer member 300. The at least one light source 200 can include a point light source, a line light source, or a surface light source, and is located on the substrate. For example, the light source assembly can use a light emitting diode (LED) or a laser source as the point light source 200. The at least one buffer member 300 can be disposed on the substrate 100, and located on the same side of the substrate 100 as the at least one light source 200.

In some embodiments, the buffer member 300 can be formed of an elastic material having a compressive property, such as silicone, plastic, or rubber. According to a heating condition of the light source 200, the buffer member 300 can be correspondingly formed of a material and a material type with a favorable heat resistance.

In order to enable the buffer member 300 to produce a favorable buffering effect, the height H2 of the buffer member 300 can be provided to be greater than the height H1 of the light source 200 along an outward normal direction of a surface of the substrate 100. Specifically, if each light source 200 is of the same height and each buffer member 300 is of the same height, the height of the buffer member 300 is greater than that of the light source 200. If a plurality of light sources 200 have different heights, a maximum height of all the buffer members 300 can be made to be greater than a maximum height of all the light sources 200.

In some embodiments, an object is provided on one side of the light source assembly, and the object might move toward the light source assembly. When the object moves toward the light source assembly in a close distance, since the height H2 is greater than the height H1, a certain gap is always maintained between the object and the light source 200 to avoid that the object directly collides with the light source 200. Moreover, the buffer member 300 also absorbs the impact energy of the object, to reduce the possibility that the light source 200 is damaged by collision, thereby enhancing the reliability of the light source assembly.

In the above-described embodiments, the buffer member having a maximum height greater than that of the light source is provided on the substrate of the light source assembly, so that the buffer member can buffer a motion of the object when the object on a side of the light source moves toward the light source, thereby reducing the risk that the light source assembly is damaged by collision with the object.

In order to improve the utilization rate of the light emitted by the light source 200, referring to FIG. 1, in some embodiments, the light source assembly further includes a reflector sheet 400. The reflector sheet 400 is located on one side of the at least one buffer member 300 away from the substrate 100. The reflector sheet 400 can partially or completely cover the surface of the buffer member 300. The reflector sheet 400 can reflect the light emitted to the surface of the buffer member 300, so as to reduce or avoid the absorption of the light by the buffer member 300.

The reflector sheet 400 can be formed in a coating manner, that is, a film layer having a reflective effect is coated on a surface of the buffer member 300. In other embodiments, the reflector sheet 400 is a reflective member having a reflective surface, which is fixed on a surface of the buffer member 300 in a manner such as adhesion.

In order to avoid a shielding effect of the buffer member 300 over the light emitted by the light source 200 as much as possible, in some embodiments, a groove structure penetrating along the outward normal direction of the surface of the substrate 100 can be alternatively provided on the buffer member 300 and can be configured to embed the light source 200. In other embodiments, it is also possible to use a plurality of buffer members 300, and allow the light source 200 to be located in a gap among the plurality of buffer members 300. In further embodiments, it is possible to use a buffer member 300 of a transparent material to cover the substrate 100 and the light source 200, or provide a transparent material at least a part of the buffer member 300 corresponding to the light source 200.

For the groove structure, in addition to being located on one side of the buffer member 300 away from the substrate 100, the reflector sheet 400 can also be located on the inner wall surface of the groove structure to improve the reflective effect. For example, in FIG. 1, a groove structure 310 (refer to FIG. 2) is provided on a surface of the buffer member 300. At least one light source 200 is embedded within the groove structure 310. The reflector sheet 400 can cover the surface of the buffer member 300 and the inner wall surface of the groove structure 310. The groove structure here can include a groove or hole with an enclosed or non-closed boundary, so long as it can accommodate at least one light source 200 to be embedded.

In order to increase an angle range of the light emitted by the light source 200, in some embodiments, the groove structure 310 can have a flared end along the outward normal direction of the surface of the substrate 100. The cross-sectional size of this flared end gradually transits from a smaller cross-sectional size on one side adjacent to the substrate 100 to a larger cross-sectional size on one side away from the substrate 100, thereby forming a structure that is gradually deployed outwards.

In the edge-type backlight module including the light source assembly of the present disclosure, the light guide plate 500 is located on a side of the light source assembly (refer to FIG. 5). The light emitted by the light source 200 does not exceed a thickness range of the light guide plate 500 as far as possible to reduce or avoid the problems of light leakage and reduced light guiding efficiency. Referring to FIG. 1, in some embodiments, the flared angle α of the flared end along the thickness direction of the light guide plate 500 is 40° to 60°, for example 50°. The selection of the flared angle α can be determined according to at least one of the size of the light source 200, the thickness of the light guide plate 500, and the distance between the light guide plate 500 and the light source 200.

FIG. 2 is a schematic structural view of a buffer member 300 in an embodiment of a light source assembly according to the present disclosure.

Referring to FIG. 2, in some embodiments, the buffer member 300 is fabricated in a strip shape to cooperate with the strip-like substrate 100. A plurality of groove structures 310 having a flared end can be provided at intervals along the length direction of the buffer member 300 (also i.e., the length direction of the substrate 100). Alternatively, the cross-sectional shape of the groove structure 310 can be rectangular, or in other shapes such as oval, diamond, and the like. In FIG. 2, the groove structure 310 having a rectangular cross section has an inner wall surface 320 along the length direction of the buffer member 300 and an inner wall surface 330 along the width direction (i.e., the thickness direction of the light guide plate 500).

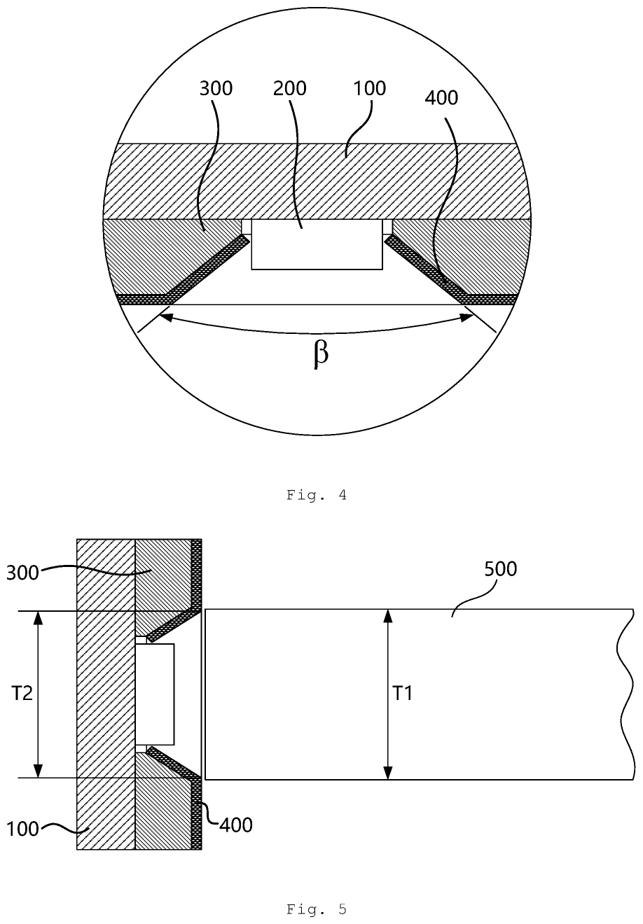

FIG. 3 is a schematic structural view of a light source assembly according to an embodiment of the present disclosure.

In FIG. 3, the substrate 100 is also fabricated in a strip shape, and a buffer member 300, a light source 200, and a power supply interface 600 are provided in a surface on one side of the substrate 100. The light source 200 is an LED point light source, and embedded within a groove structure 310 provided on the buffer member 300.

FIG. 4 is an enlarged schematic view of a circle A in FIG. 3.

Referring to FIG. 4, in some embodiments, considering factors such as the light emitting angle of the light source 200 itself and the spaced width of the light sources 200 in the strip-like substrate 100, the flared end of the groove structure 310 can have a flared angle β of 90°˜150°, for example 120° along the length direction of the substrate 100. By providing a proper flared angle β, the light emitted by each light source 200 can enter the light guide plate 500 (refer to FIG. 5) as much as possible, thereby improving the efficiency of the light source assembly.

FIG. 5 is a schematic structural view of a backlight module according to an embodiment of the present disclosure.

Referring to FIG. 5, in some embodiments, the backlight module includes a light guide plate 500 and the above-described light source assembly. The light guide plate 500 is located on one side of the at least one buffer member 300 away from the substrate 100. The backlight module can be an edge-type backlight module, and in other embodiments, it can also be a backlight module in other forms. For example, for some edge-type backlight modules provided in a vibration scenario, the buffer member 300 can effectively reduce the impact between the light guide plate 500 and the light source assembly brought by vibration, and avoid that the light source 200 is damaged by collision with the light guide plate 500.

The groove structure 310 provided on the surface of the buffer member 300 can have a flared end along the outward normal direction of the surface of the substrate 100. The flared size T2 of the flared end along the thickness direction of the light guide plate 500 is no greater than the thickness T1 of the light guide plate 500 so as to reduce or avoid problems of light leakage and reduced light guiding efficiency.

The above-described embodiments of the backlight module can be used for various types of devices in which backlight is required, such as a display device or a lighting device. Therefore, the present disclosure also provides an embodiment of a display device, which includes the above-described backlight module. For example, in a liquid crystal display device having a liquid crystal panel, any embodiment of the above-described edge-type backlight module of the present disclosure can provide backlight for the display of the liquid crystal panel. By using the foregoing embodiment of a backlight module, the display device embodiment can be applied to a vibration scenario (e.g., use in a vehicle), so as to obtain better reliability.

Hereto, various embodiments of the present disclosure have been described in detail. Some details well known in the art are not described to avoid obscuring the concept of the present disclosure. According to the above description, those skilled in the art would fully know how to implement the technical solutions disclosed herein.

Although some specific embodiments of the present disclosure have been described in detail by way of examples, those skilled in the art should understand that the above examples are only for the purpose of illustration and are not intended to limit the scope of the present disclosure. It should be understood by those skilled in the art that modifications to the above embodiments and equivalently substitution of part of the technical features can be made without departing from the scope and spirit of the present disclosure. The scope of the present disclosure is defined by the appended claims.

1. A light source assembly comprising:
a substrate;
at least one light source located on the substrate; and
at least one buffer member located on the substrate and located on the same side of the substrate as the at least one light source, wherein a maximum height of the at least one buffer member is greater than a maximum height of the at least one light source.

2. The light source assembly according to claim 1, further comprising:
a reflector sheet located on one side of the at least one buffer member away from the substrate.

3. The light source assembly according to claim 1,
wherein the at least one buffer member has a groove structure penetrating along an outward normal direction of a surface of the substrate, and the at least one light source is embedded within the groove structure.

4. The light source assembly according to claim 3, further comprising a reflector sheet, wherein the reflector sheet is located on one side of the at least one buffer member away from the substrate and on an inner wall surface of the groove structure.

5. The light source assembly according to claim 3, wherein the groove structure has a flared end along the outward normal direction of the surface of the substrate.

6. The light source assembly according to claim 5, wherein the flared end has a flared angle of 40°˜60° along a thickness direction of a light guide plate.

7. The light source assembly according to claim 5, wherein the flared end has a flared angle of 90°˜150° along a length direction of the substrate.

8. A backlight module comprising:
a light source assembly; and
a light guide plate,
wherein the light guide plate is located on one side of the at least one buffer member away from the substrate,
wherein the light source assembly comprises:
a substrate;
at least one light source located on the substrate; and
at least one buffer member located on the substrate and located on the same side of the substrate as the at least one light source, wherein a maximum height of the at least one buffer member is greater than a maximum height of the at least one light source.

9. The backlight module according to claim 8, wherein a surface of the at least one buffer member is provided with a groove structure having a flared end along an outward normal direction of a surface of the substrate, and a flared size of the flared end along a thickness direction of the light guide plate is no greater than a thickness of the light guide plate.

10. A backlight module comprising:
a light source assembly; and
a light guide,
wherein the light guide plate is located on one side of the at least one buffer member away from the substrate;
wherein light source assembly comprises:
a substrate;
at least one light source located on the substrate; and
at least one buffer member located on the substrate and located on the same side of the substrate as the at least one light source, wherein a maximum height of the at least one buffer member is greater than a maximum height of the at least one light source;
wherein the at least one buffer member has a groove structure penetrating along an outward normal direction of a surface of the substrate, and the at least one light source is embedded within the groove structure; and the groove structure has a flared end along the outward normal direction of the surface of the substrate.

11. The backlight module according to claim 10, wherein a flared size of the flared end along a thickness direction of the light guide plate is no greater than a thickness of the light guide plate.

12. A display device, comprising the backlight module according to claim 8.

13. A display device, comprising the backlight module according to claim 10.
